(19) United States
(12) Patent Application Publication
(10) Pub. No.: US 2022/0015528 A1
(43) Pub. Date: Jan. 20, 2022

(54) CAMPING FIRE-JUG

(71) Applicant: Jonathan Ralph BURDICK, St. Louis, MO (US)

(72) Inventor: Jonathan Ralph BURDICK, St. Louis, MO (US)

(21) Appl. No.: 17/381,176

(22) Filed: Jul. 20, 2021

Related U.S. Application Data
(60) Provisional application No. 63/054,027, filed on Jul. 20, 2020.

(51) Int. Cl. A45F 3/08; A45F 3/20; G08B 5/00; A01M 29/12; A01M 31/00; A01K 85/01

(52) U.S. Cl. CPC A45F 3/08; A45F 3/20; G08B 5/002; A45F 2003/003; A01M 31/00; A01K 85/01; A01M 29/12

(57) ABSTRACT

A wilderness survival apparatus is provided which serves as: (a) a container for potable drinking water; (b) a container for pasteurizing liquids; (c) a burning lens for firestarting; and (d) a rescue signaling device. The apparatus comprises a low-cost, lightweight, compactible and reusable system which can be easily integrated into, or replace, existing outdoor gear such as pillows or padding and whose manufacture is readily integratable with existing outdoor gear manufacturing.

### RELATED APPLICATIONS

This application claims priority to U.S. Provisional Application 63/054,027 that was filed Jul. 20, 2020 and which is fully incorporated herein by reference.

### BACKGROUND OF THE INVENTION

### Field of the Invention

The present invention relates generally to the field of outdoor camping and wilderness survival equipment, more specifically the invention relates to multi-function portable liquid containers, and most specifically the invention relates to a portable liquid container formable as a magnifying lens when filled with clear liquid.

### Description of the Related Art

The number of hikers, campers and backpackers who require SAR (search-and-rescue) assistance continues to increase. People in need of rescue can benefit from having survival gear in their possession when lost or stranded, equipment which can mean the difference between life and death. A common theme voiced by practitioners of wilderness survival skills is that some of the best survival gear includes objects which can perform multiple unrelated functions. A piece of camping gear may be optimized for one or more uses, but may be capable of additional uses not commonly envisioned e.g. ad hoc uses in emergency medical and/or wilderness survival scenarios. For example a tent cord may prove useful in fashioning a tourniquet.

When determining a load-out for a wilderness expedition great attention must be paid to packing everything necessary for the trip. Generally, the longer the trip the more gear must be taken along much of which may or may not be replaceable en route. For example, consumables such as food. Additionally, conditions such as weather can adversely affect an expedition party, resulting in loss of firestarting equipment and water supplies or damage that renders such items unusable. For these reasons, especially when camping in remote areas, it becomes paramount to pack the most practical arrangement of items available including, quite often, a small kit of special survival gear intended for use if the camping expedition goes awry and basic survival becomes an issue. Such survival kits commonly contain a variety of useful items many of which are characterized by (a) compactness in storage, and/or (b) a capability of performing multiple unrelated functions.

What is needed is a low-cost, lightweight, compact and reusable system, and associated methods, for accomplishing the above-listed purposes which system can be readily integrated into existing camping gear and whose manufacture can be readily integrated into existing gear manufacturing.

### SUMMARY OF THE INVENTION

With all of the foregoing in mind, it is an object of the present invention to provide a container: (a) for potable drinking water; (b) for disinfecting liquids; (c) for serving as a burning lens for firestarting; (d) for serving as a signaling device for rescue; and (e) for serving as a container for various preparable mixtures. While currently available products may serve one or more of these purposes nothing performs these functions with all the advantages accruing as described herein. Optimally, the system adds almost no weight to, and takes up almost no space in or on, a camper's existing method of transporting his or her camping gear such as a rucksack or backpack.

In a general embodiment, the invention provides an apparatus for use in outdoor camping environments, which includes a flexible larger single container composed of a translucent flexible polymer material, and a plurality of smaller containers composed of a translucent flexible polymer material, wherein said polymer has a thickness and composition which are promotive of durability as against typical physical forces encountered when attached to the lower rear portion of a backpack frame and situated between a user and the backpack frame while a user is walking at a normal pace carrying the backpack. Further, each shape of the container and of the smaller container is a generally an oloid when filled with water and suspended vertically such that the x,y oloidal axis is perpendicular to the ground and the shape of the formable oloid is approximately that of a convex lens. The invention further provides means for attaching the container and smaller containers to a conventional backpack frame, and at least one breakable capsule inside at least the larger or a smaller container which capsule contains a compound that reacts with water to form either a useful mixture or a useful reaction product.

More complex embodiments of the invention are also disclosed. For example, the polymer material may selected to substantially resists creasing and crinkling, or may be made from a bioplastic, a biodegradable plastic, or a shape-memory polymer. Or, the invention my be designed so that the larger single container is attached to the array of smaller containers, such as three, via grommets and cordage. The smaller containers may be disposed to form a single-row array along a generally rectangular strip such that when said containers are substantially filled with water the strip is attachable as padding between the lower portion of a human back and the lower portion of a conventional backpack frame.

In another embodiment, the apparatus may be designed so that the larger single container is both small enough and large enough when substantially empty to fit snugly between the upper portion of a human back and the upper portion of a conventional framed backpack. In another embodiment, the apparatus may be designed so that water added to substantially fill either the larger container or any smaller container renders such substantially water-filled larger or smaller container usable to focus sunlight as a burning lens. In another embodiment, the apparatus may be designed so that water may be disinfected when the apparatus is used as a heat resistant container in which to heat the water via a heat source. In other embodiments, the apparatus may be designed so that at least one capsule is usable to render the liquid contents into a durable writing ink useful for creating markings visible to rescuers, or into an odiferous substance known to repel common predator animals, or into an odiferous substance known to resemble an attractant scent typical of bait used to attract game such as an attractant scent typical of chum used to attract fish.

In other implementations, the apparatus as described in the general embodiment may be designed so that the liquid contents are used to render the liquid contents into a nutritionally useful mixture or into a medically useful mixture. Or, the general embodiment may be further designed for rescue signaling by including a breakable capsule in one of the containers able to create light-versus-dark or dark-versus light color contrast for improved day visibility by rescuers, or able to create luminescent color contrast for improved night visibility by rescuers. In any of the foregoing embodiments that create color contrast, the invention may provide, after the capsules are mixed with water, liquid contents that remain safe for human consumption.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. In the drawings, like reference numerals may designate like parts throughout the different views, wherein:

FIG. 1 is a perspective view of a conventional backpack frame assembly on the left and on the right a perspective view of one embodiment of a camping fire-jug apparatus according to the invention as installed on a backpack frame assembly.

FIG. 2 shows a perspective view of another embodiment of the camping fire-jug invention, along with detailed views of further aspects thereof.

FIG. 3 depicts oblique, side, frontal, and top views of another embodiment of a camping fire-jug according to the invention.

FIG. 4 shows frontal and side views of a component part of the invention.

FIG. 5 is an illustrated block diagram depicting a method for focusing sunlight for firestarting using a camping fire-jug according to the invention.

FIG. 6 is an illustrated block diagram depicting a method for disinfecting liquid water using heat sources harnessed by a camping fire-jug according to the invention.

FIG. 7 is an illustrated block diagram depicting methods using a camping fire-jug to accomplish signaling for rescue according to the invention.

### DETAILED DESCRIPTION OF THE INVENTION

The usefulness of fire and potable water to camping enthusiasts is difficult to overestimate. A camper who is lost and in need of rescue may die within three days without water. Many who are lost in the wilderness can die from hypothermia unless a heat source such as fire can be secured.

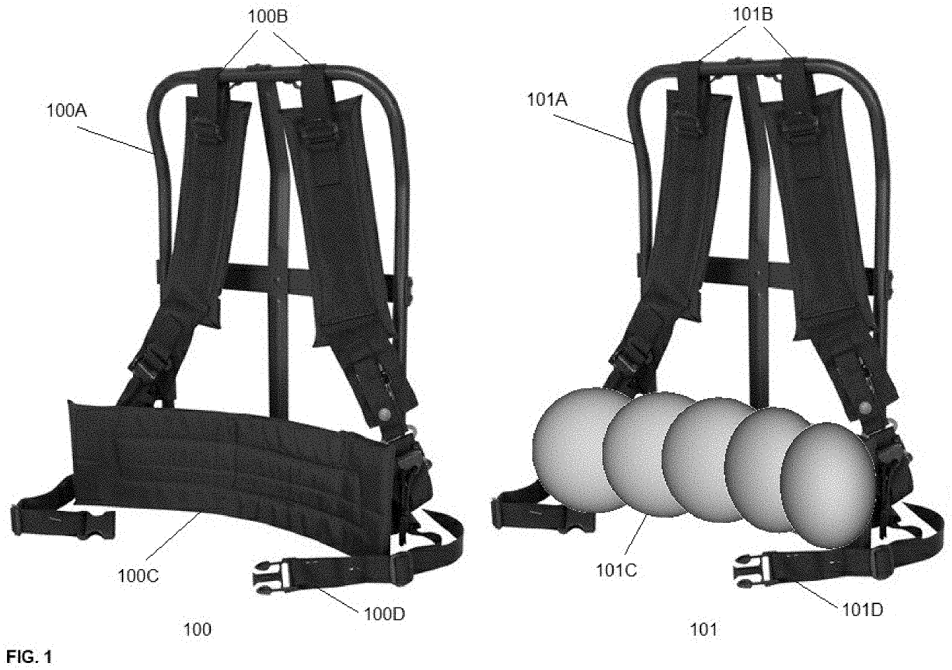

FIG. 1 shows on the left a conventional backpack frame assembly and on the right a similar backpack frame assembly adapted for use with one aspect of the invention. With regard to FIG. 1, conventional backpack frame assembly 100 includes frame proper 100A to which are affixed a pair of shoulder straps 100B, comfort padding 100C, and hip belt 100D. Comfort padding 100C is commonly composed of foam padding enclosed in a resilient fabric.

With further regard to FIG. 1, backpack frame assembly 101 includes frame proper 101A to which are affixed a pair of shoulder straps 101B, inventive padding 101C, and hip belt 101D. Inventive padding 101C is composed of potable water enclosed in five equal-sized containers manufactured from a translucent polymer material. The containers form a single row and are adjacent but not overlapping. The containers need not be filled to capacity and in preferred embodiments a user may adjust the water levels for his or her comfort. Additionally, it is noted that the containers can be filled with differing water levels which can be useful if an unbalanced load must be hauled.

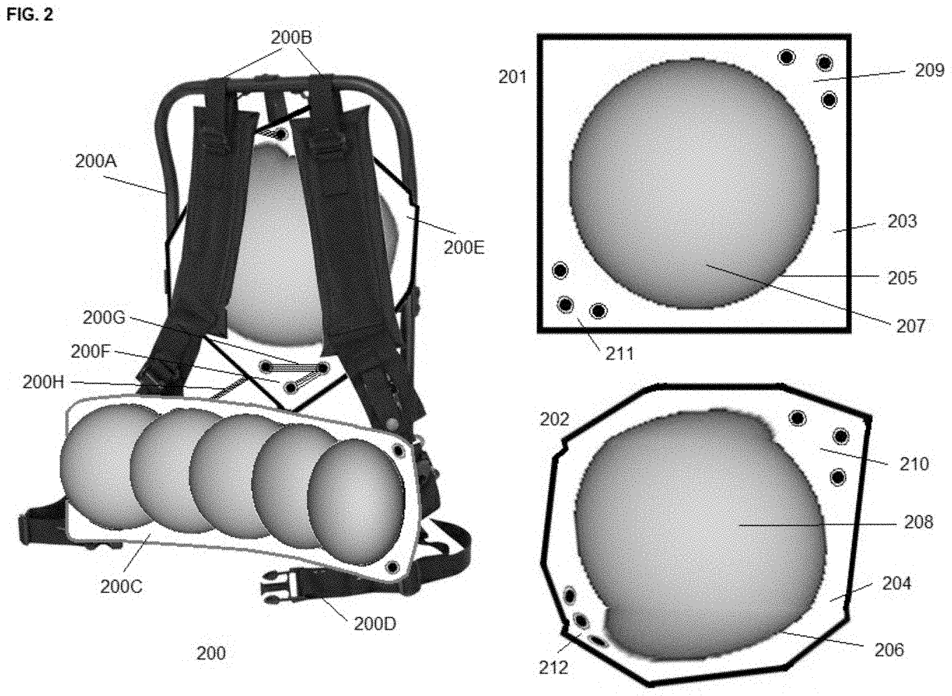

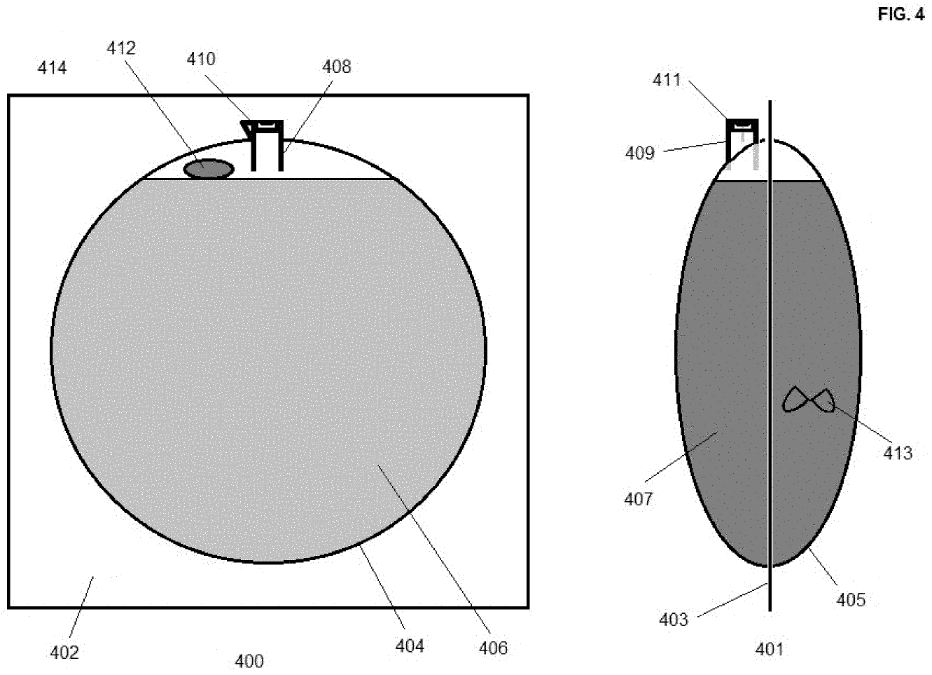

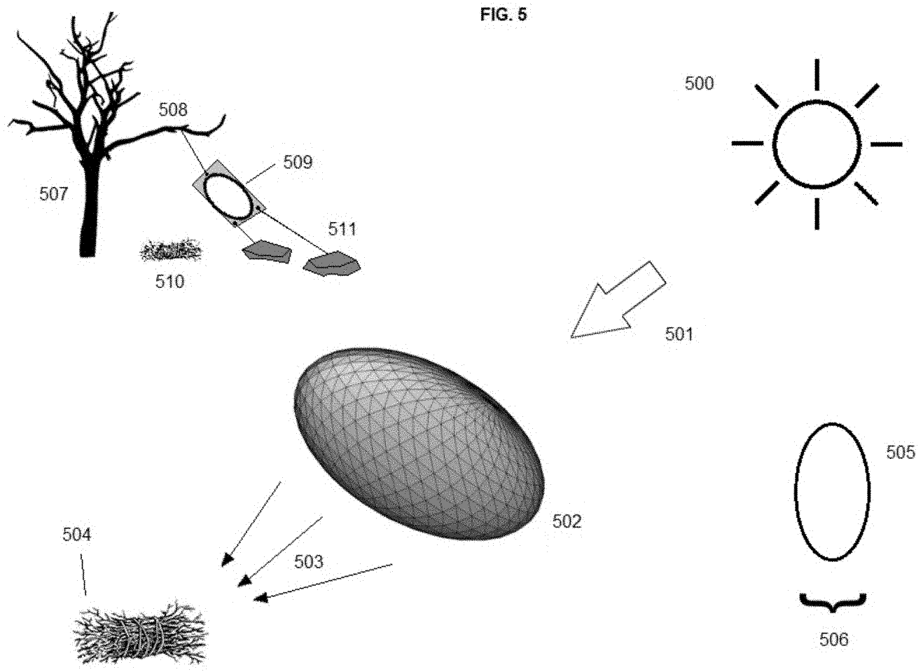

FIG. 2 shows a conventional backpack frame adapted for use with further aspects of the invention, and a detailed view of such further aspects. With regard to FIG. 2, backpack frame assembly 200 includes user-supplied frame proper 200A to which are affixed a pair of shoulder straps 200B, inventive padding 200C, and hip belt 200D. Inventive padding 200C is composed of water enclosed in five equal-sized, generally round containers (“small fire-jugs”) manufactured from a translucent polymer material which small fire-jugs are embedded in or otherwise disposed on a generally rectangular strip which strip is affixed to frame proper 200A. The rectangular strip may be composed of a polymer or other material which is of a sufficient thickness so as to be somewhat rigid but also somewhat flexible. In this configuration, inventive padding 200C serves as a comfort padding and also as a container for water. Any tabs or cap mechanisms (not shown in FIG. 2, but such as are described hereinbelow with regard to FIG. 4) extending from fire-jugs of inventive padding 200C may be positioned so that they are facing toward backpack frame assembly 200 and thus will not come in contact with a user's body. Moreover, although not shown in FIG. 2 a piece or pieces of durable canvas fabric or similarly suitable material (with or without additional thin padding material attached thereto, such as by being sewn onto such canvas) may be detachably affixed (e.g. with velcro fastening) to one or both sides of the rectangular strip of inventive padding 200C to protect inventive padding 200C while inventive padding 200C is affixed to frame proper 200A. In some embodiments, an eco-friendly bioplastic or biodegradable shape-memory polymer is used which has desired properties of sufficient translucence, heat resistance, durability, and crinkle resistance. By way of example and not limitation the polymer may be low density polyethylene (LDPE), linear low density polyethylene (LLDPE), high density polyethylene (HDPE), a LLDPE/HDPE blend, polyhydroxyalkoanate (PHA), polylactic acid (PLA), a PHA/PLA blend, or MarinaTex (fish scale composite). Conventional strengthening additives known to those skilled in the art may be incorporated into one or more such polymers. In addition, polymer thickness may be varied across the surface of the fire-jug so that a generally convex lens shaping achieved by positioning it with a user's hands is more easily retained when the fire-jug is being positioned at an angle (relative to ground level) appropriate for catching sun rays, as further described hereinbelow with regard to FIG. 5.

With further regard to FIG. 2, additional inventive padding (“large fire-jug”) 200E is composed of a water container manufactured from a translucent polymer material which container is larger in size than one of the small fire-jugs, is embedded in or disposed on a generally square patch, and is generally of a similarly round shape as compared with a small fire-jug. The large fire-jug 200E is shown in FIG. 2 as empty of all water and devoid of almost all air because in this configuration it is intended simply for transport and is positioned unobtrusively behind shoulder straps 200B and in front of frame proper 200A. Alternatively, the empty large fire-jug 200E may be placed between frame proper 200A and a user-supplied frame-mounted backpack. Located within large fire-jug 200E are a set of three grommets 200F and a similar set of three grommets (only one of which is shown) located on the opposite side of large fire-jug 200E. Wrapped through grommet set 200F is cordage 200G (by way of example and not limitation, military grade 550 parachute cord) which continues behind large fire-jug 200E, through location 200H, and is attached to a grommet (not shown) located within strip of inventive padding 200C. Cordage 200G at its other end may continue upwards for example and be affixed as shown to the grommet visible near the top of frame proper 200A, and any loose cordage may be easily tucked in and around, and tied to, itself, to remain unobtrusive. A small clip (not shown) with an attachment hole is included to facilitate cordage attachment to the frame. As an alternative to the configuration shown, a user may opt to simply roll up the apparatus and carry the apparatus in his or her rucksack or backpack.

With further regard to FIG. 2, large fire-jug 201 is shown fully stretched-out and suspended vertically in the air. Large fire-jug 201 includes square strip 203 embedded within which or otherwise disposed on which is liquid pouch 205 containing a quantity of liquid 207. As viewed within FIG. 2 the two-dimensional representation of liquid pouch 205 presents a generally circular outer perimeter, however by way of example and not limitation the outer perimeter of liquid pouch 205 may instead present an outline of a different though similarly functional shape such as a Reuleaux polygon, e.g. a Reuleaux quadrilateral. Located within square strip 203 are grommet sets 209 and 211. By contrast, large fire-jug 202 is shown slightly crumpled and suspended vertically in the air. Large fire-jug 201 includes square strip 204 which is correspondingly crumpled. Embedded within or otherwise disposed on square strip 204 is liquid pouch 206 which is empty 208 of all contents save a very small amount of air. Located within square strip 204 are grommet sets 210 and 212. Large fire-jug 202 being flattened out and devoid of liquid and air is therefore able to be unobtrusively attached to frame proper 200A. Those skilled in the art will recognize that in this configuration, water carried in the large and/or small fire-jugs may be consumed through user-supplied tubing employed so that the user may drink through the tubing while walking, similar to the way in which CamelBak® systems are used.

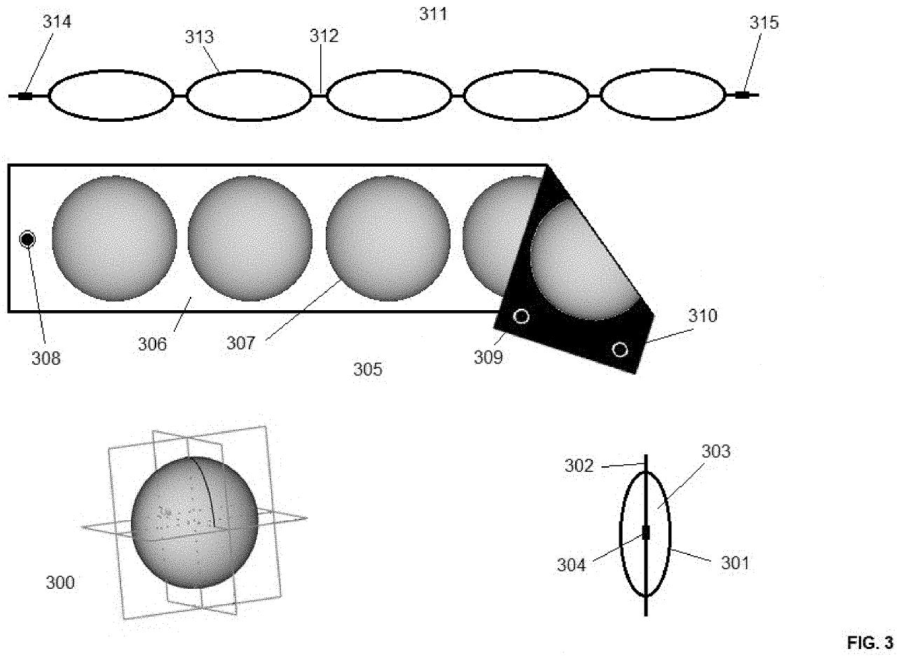

FIG. 3 depicts an oblique view, a side view, a frontal view, and a top view, of one aspect of the invention and several of its component parts. With regard to FIG. 3, a fire-jug liquid container 300 is shown from an oblique perspective with x,y,z coordinate axes provided as a visual aid indicative of its approximate relative dimensions. As can be seen, fire-jug liquid container 300 has a generally disk-like shape which it assumes when substantially filled with a liquid (as is shown). The diameter of fire-jug liquid container 300 is equal in the x,y and y,z planes and has a diameter in the x,z plane approximately half that of the x,y (or y,z) plane.

With further regard to FIG. 3, a side view of an empty (though not deflated; e.g., when blown full of air) fire-jug liquid container depicts corresponding side-view perspectives of its polymer membrane 301, rectangular strip 302, interior region 303, and grommet 304 which grommet is located within rectangular strip 302. Note that a similar view (not shown) from the other side of the fire-jug liquid container would show a set of two grommets rather than only one grommet.

Again with regard to FIG. 3, a frontal view of folded belt 305 of liquid-filled small fire-jugs shows corresponding frontal perspectives of the belt's rectangular strip 306, a set of five liquid containers 307, grommet 308 and a set of two grommets (309 and 310). Rectangular strip 306 is depicted as being folded over, across itself, on the right side. The folding-over is intended to reveal that the opposite (rear) side of rectangular strip 306 has a substantially dark coloring in contrast to the front side which has a substantially light coloring. By way of example and not limitation, such rear side of rectangular strip 306 may instead be a different coloring such as reflective orange, reflective yellow, reflective metallic, etc. as may the coloring of a square strip (which houses a large fire-jug) likewise vary. Grommets 308, 309 and 310 are preferably composed of lightweight metal or other durable material and attached conventionally. Distance between each of the five liquid containers 307 is equal as between containers and is shown in FIG. 3 only approximately and not to scale.

And again with regard to FIG. 3, a top view of a belt 311 of empty (but inflated with air) small fire-jugs shows corresponding top-view perspectives of the belt's rectangular strip 312, a set of five liquid containers 313, grommets 314 and 315 (a third grommet, behind grommet 315 in this perspective, is not shown).

FIG. 4 shows frontal and side views of a component part of the invention. With regard to FIG. 4, large fire-jug 400 is shown from a frontal view, vertically disposed and comprising square patch 402, and liquid container pouch 404 within which liquid water 406 (not supplied integrally with the invention, but added by a user) is contained. An orifice 408 protrudes outward from within and through liquid container pouch 404 and is capped by an affixed cap mechanism 410. Liquid may enter and exit liquid container pouch 404 via orifice 408 when cap mechanism 410 is open, and orifice 408 is large enough so that if no water is available urine can effectively be passed into the fire-jug either directly or with a makeshift funnel, and the fire-jug filled with urine can be used for firestarting as described hereinbelow with regard to FIG. 5. Cap mechanism 410 may be of a conventional design which snaps shut when a user presses it into orifice 408 and closes snugly enough so that for example it will remain closed if a full pouch of water is hung upside down. Alternatively, rather than permitting and preventing liquid flow via cap mechanism 410, liquid container pouch 404 may instead permit and prevent liquid flow via a strong snap seal mechanism integrated within the surface of part of the upper region of the pouch, said snap seal mechanism functioning similarly to the way a plastic baggie may be snapped shut near its top. Such snap seal mechanism is not shown in FIG. 4, however such snap seal mechanism if implemented occupies an arc region across an upper portion of the pouch generally near where cap mechanism 410 is shown. Said snap seal mechanism may be pinched shut and/or pulled open by a user, though with more force required than generally used to open and close a plastic baggie. Alternatively, the invention may be constructed so that the user “peels apart” a single-grommeted corner of a fire-jug strip (horizontal or square strip) generally in the same way a user peels apart the top portion of a plastic baggie; in this construction, the user peeling of the corner of the strip continues until the peeling action reaches a snap seal mechanism which is then is forced open until further peeling is not possible. The snap seal mechanism will seal a pouch opening which is large enough to permit the same functions described above with respect to a cap mechanism. A fire-jug with a snap seal mechanism may be slightly more prone to leaking due to an inadvertently burst-open snap seal, however an advantage gained is that a fire-jug with a snap seal mechanism is easier to fill with liquids and especially easier to fill with snow or ice, the preferred method for using a cap lockable fire-jug with snow or ice being to repeatedly push small amounts of snow or ice into the pouch through orifice 408 using a found twig or other matter at hand. The invention may be constructed using a combination of these two different types of sealing mechanisms. In one embodiment a group of smaller fire-jugs has a cap mechanism for each fire-jug, and one large fire-jug has a snap seal mechanism.

With further regard to FIG. 4, floating on the surface of liquid water 406 is capsule 412 which contains a substance which when released upon capsule rupture disperses in the water and which, due to biochemical reactions, causes the water to exhibit bioluminescence however after capsule rupture the liquid water (if it was originally potable) remains safe for human consumption. A current manufacturer of this type of substance is Biolume, Inc. (http://biolume.net/). In preferred embodiments, a fire-jug is still capable of focusing the sun's rays to a useful extent even after the bioluminescence capsule is ruptured and its contents released into contained water (for example, on a very bright day). Alternatively, capsule 412 may contain other substances depending upon user preferences e.g. salt, electrolytes, medicine, water purification tablets, etc. In preferred embodiments, multiple capsules are stored in liquid container pouch 404 though not so many as to adversely affect other functionality of the invention. For example, a pouch might contain four capsules: each of three capsules, integral to the invention, when ruptured produces a differently hued bioluminescence (such as red, yellow, and blue) and the user adds their own breakable quinine capsule to guard against malaria. May other types of capsules may be used with the invention; by way of nonlimiting examples: coloring tablets for trail marking, or tablets which change color noticeably after water in which it is suspended reaches pasteurization temperature of approximately 160° F.; tablets which when moistened produce a malodorous scent repellant to animals; and moistenable attractant tablets useful for baiting game traps.

Again with regard to FIG. 4, large fire-jug 401 is shown from a side view with characteristics similar to those of large fire-jug 400. Large fire-jug 401 is vertically disposed and comprises square patch 403, and liquid container pouch 405 within which bioluminescent liquid 407 (caused by capsule rupture) is contained. An orifice 409 protrudes outward from within and through liquid container pouch 405 and is capped by an affixed cap mechanism 411. In this side view, part of the lower portion of orifice 409 is shown partially obscured because it is contained within the interior region of liquid container pouch 405. Liquid may enter and exit liquid container pouch 405 via orifice 409 when cap mechanism 411 is open. Cap mechanism 411 may be of a conventional design which snaps shut when a user presses it into orifice 409 and closes snugly enough so that for example it will remain closed if a full pouch of water is hung upside down. Broken capsule 413 is shown submerged in bioluminescent liquid 407 following intentional rupture by a user. To rupture the capsule, a user simply pinches the capsule between a thumb and finger and squeezes vigorously.

FIG. 5 depicts a method using the invention to focus sunlight for firestarting. With regard to FIG. 5, on a sufficiently clear day the sun 500 will produce rays 501 which are focused by the convex lensing of fire-jug 502 and strike tinder 504 eventually causing it to ignite. To focus the sun's rays in this manner, a user may simply grasp fire-jug 502 and position it perpendicular to rays 501 while adjusting the focused light for maximum focal concentration onto tinder 504. This may be accomplished with either a small fire-jug or a large fire-jug, by moving it closer to or further from the sun as needed, with the large fire-jug more effective in overcast weather than the small fire-jug is. Each fire-jug, large or small, produces a burning lens as shown in silhouette 505 when the fire-jug contains a sufficient amount of water, with the approximate lensing thickness 506 of the lens being close to optimal for firestarting magnification. Depending upon the material of which a fire-jug is manufactured, and the material's thickness, it may be beneficial for a user to fill the fire-jug with water or other liquid and then, to achieve a superior lensing shape, force a small additional amount of water or other liquid (such as by mouth expulsion, syringe, mini-pump, etc.) into a fire-jug prior to focusing sunlight.

With further regard to FIG. 5, some users may experience more difficulty in wielding the large fire-jug when it is filled with water, and may wish to use the supplied cordage and two grommets to deploy the large fire-jug athwart the sun's rays. In such case, a user may wish to use a tree 507 having branch 508 and supplied cordage to suspend large fire-jug 509 in mid-air by attaching the cordage from branch 508 to the centered grommet of large fire-jug 509 and attaching remaining cordage from the two noncentered grommets of large fire-jug 509 to the ground by placing local rocks 511 of sufficient size atop the cordage on the ground, emplacing the rocks as needed. In this manner, large fire-jug 509 remains generally stable enough to focus the sun's rays and thereby ignite tinder pile 510. The user may grasp the lower cordage and move it as necessary to make fine adjustments to the focal spot, and steady the apparatus during windy conditions.

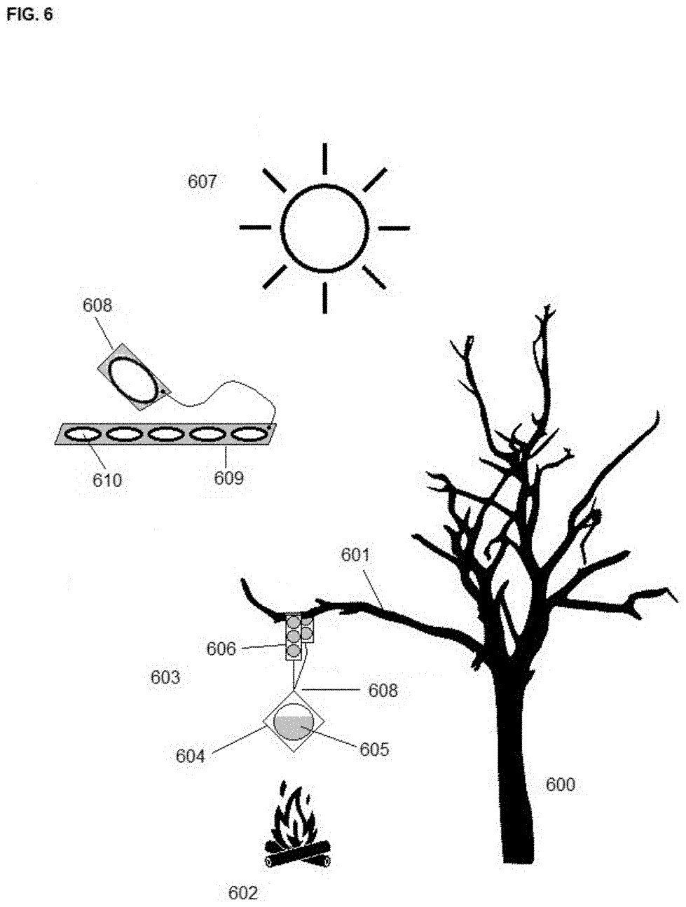

FIG. 6 depicts methods using the invention to disinfect liquid water using heat sources. With regard to FIG. 6, from a tree 600 extends branch 601 which overhangs campfire 602. Draped over branch 601 is fire-jug assembly 603 comprising square patch 604 and liquid container pouch 605 of a large fire-jug containing water, and five small fire-jugs 606 disposed on a rectangular strip. Cordage at one end of small fire-jugs 606 is tied to its single-grommeted end through the grommet and tied to a grommet on the large fire-jug as shown. Cordage at the other end of small fire-jugs 606 is also tied to a grommet on the large fire-jug at location 608. By controlling the heat of campfire 602 and the height of the large fire-jug above the fire, water may be pasteurized in a very reasonable amount of time. The general method is well-known and preferably practiced so that a significant amount of water is pasteurized though the container is less than completely full.

With further regard to FIG. 6, a known way of disinfecting water is via UV rays from the sun. Typically, these rays will disinfect generally clear water such that the water is potable in approximately six hours at minimum, depending upon water turbidity and any overcast clouds in the sky. The amount of time can be significantly reduced, however, by heating the water with an external heat source while the water is absorbing the sun's rays. In FIG. 6, rays from the sun 607 are focused by large fire-jug 608 toward small fire-jug assembly 609 and strike small fire-jug 610. This may be accomplished simply by grasping large fire-jug 608 and holding it in position, or the technique using a tree branch may be used as described above with regard to FIG. 5. By keeping the focused light below the maximum focus and moving the focal spot across small fire-jug 610, the user may cause water in small fire-jug 610 to heat to solar disinfection temperatures more rapidly though without burning through the polymer material of which small fire-jug 610 is composed.

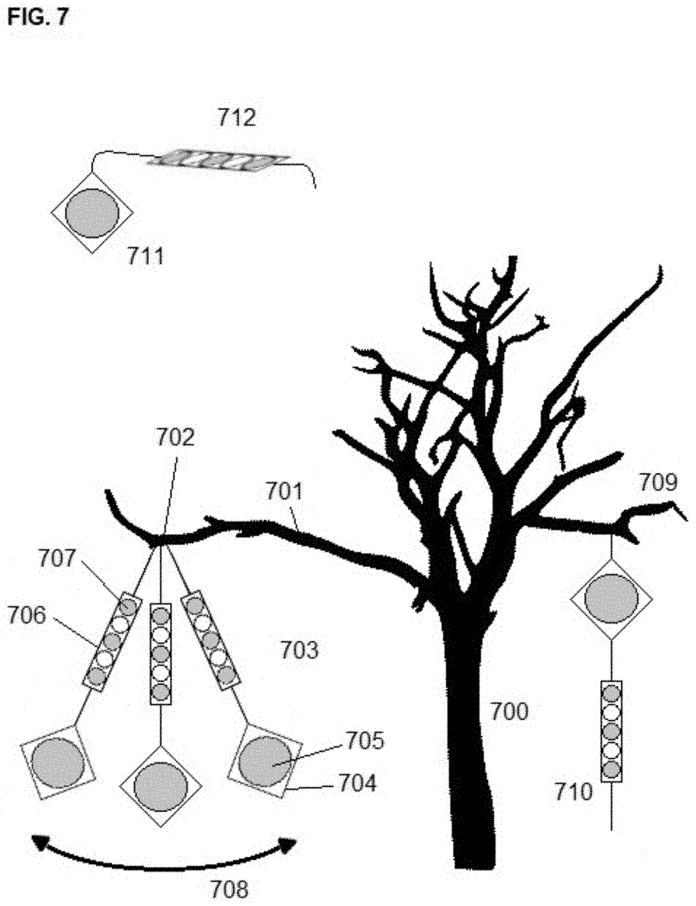

FIG. 7 depicts methods using the invention to accomplish signaling for rescue. With regard to FIG. 7, from a tree 700 extends branch 701 which overhangs a section of ground which has no major obstructions present. Attached to and suspended from branch 701 is fire-jug assembly 703 comprising square patch 704 and liquid container pouch 705, of a large fire-jug containing bioluminescent liquid, and five small fire-jugs 706 disposed on a rectangular strip. Three of the five small fire-jugs 706 contain bioluminescent liquid and the other two small fire-jugs 706 are empty, such that the two empty fire-jugs are each situated in between two of the three liquid-containing fire-jugs. Small fire-jug 707 is one of the three liquid-containing fire-jugs. Fire-jug assembly 703 is tied via cordage to branch 701 at location 702 with the large fire-jug in the low position. As shown, fire-jug assembly 703 occupies three different positions at various times because it is swinging freely along pendular arc 708 after having been set in motion by a user. Bioluminescence has been caused by the user because it is dusk or nighttime. In this manner, the user may periodically impart motion to fire-jug assembly 703 in order to increase his or her chances of being seen by rescuers. Those skilled in the art will recognize that even a small amount of clear water (e.g. if bioluminescence capsules are no longer available) placed in a fire-jug for signaling as described in FIG. 7 can produce a rippling-like visual effect when moving and struck by a flashlight beam.

With further regard to FIG. 7, an alternative technique for rescue signaling is shown which may be deemed preferable for situations in which sighting over longer distances is envisioned and/or when the user is sleeping or otherwise engaged. In this technique, fire-jug assembly 710 has its large fire-jug and three of its small fire-jugs activated for bioluminescence and fire-jug assembly 710 is suspended from branch 709 with the large fire-jug attached to branch 709 as shown with the small fire-jugs suspending below the large fire-jug. In addition, though not shown, supplied cordage may be utilized so that the large fire-jug is rendered perpendicular with the small fire-jugs so that the apparatus swings better when used for unattended signaling in windy conditions.

Again with regard to FIG. 7, an additional technique for rescue signaling is shown which may be deemed preferable for situations in which sighting from an aircraft is envisioned. In this technique, large fire-jug 711 is facing horizontally (along the ground line) for ground sighting however small fire-jug assembly 712 is facing primarily upward toward the night sky.

Those skilled in the art will recognize that the described invention is capable of being adapted to serve in various conventional roles, in addition to the novel uses described, such as: pillow, water collector, flotation assistance device, wound compress, etc. The described invention may also be useful in conjunction with various improvisational methods, such as being used to slowly drip a bioluminescent or otherwise colored liquid when traveling in order to assist rescue trackers.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

1. An apparatus for use in outdoor camping environments comprising:
a flexible larger single container composed of a translucent flexible polymer material;
a plurality of smaller containers composed of a translucent flexible polymer material;
wherein said polymer has a thickness and composition which are promotive of durability as against typical physical forces encountered when attached to the lower rear portion of a backpack frame and situated between a user and the backpack frame while a user is walking at a normal pace carrying the backpack;
wherein said container's and smaller containers' shapes each is a generally an oloid when filled with water and suspended vertically such that the x,y oloidal axis is perpendicular to the ground and the shape of the formable oloid is approximately that of a convex lens;
means for attaching the container and smaller containers to a conventional backpack frame; and
at least one breakable capsule inside at least the larger or a smaller container which capsule contains a compound that reacts with water to form either a useful mixture or a useful reaction product.

2. The apparatus of claim 1 wherein said polymer substantially resists creasing and crinkling.

3. The apparatus of claim 2 wherein said polymer is selected from the group consisting of: a bioplastic, a biodegradable plastic, a shape-memory polymer.

4. The apparatus of claim 2 wherein said polymer is selected from the group consisting of: LDPE, LLDPE, HDPE, a LLDPE/HDPE blend, PHA, PLA, a PHA/PLA blend, MarinaTex.

5. The apparatus of claim 1 wherein the larger single container is attached to the array of smaller containers via grommets and cordage.

6. The apparatus of claim 1 wherein the number of smaller containers is at least three.

7. The apparatus of claim 1 wherein the smaller containers are disposed to form a single-row array along a generally rectangular strip such that when said containers are substantially filled with water the strip is attachable as padding between the lower portion of a human back and the lower portion of a conventional backpack frame.

8. The apparatus of claim 1 wherein the larger single container is both small enough and large enough when substantially empty to fit snugly between the upper portion of a human back and the upper portion of a conventional framed backpack.

9. The apparatus of claim 1 wherein water added to substantially fill either the larger container or any smaller container renders such substantially water-filled larger or smaller container usable to focus sunlight as a burning lens.

10. The apparatus of claim 1 wherein water may be disinfected when the apparatus is used as a heat resistant container in which to heat the water via a heat source.

11. The apparatus of claim 1 wherein at least one capsule is usable to render the liquid contents into a durable writing ink useful for creating markings visible to rescuers.

12. The apparatus of claim 1 wherein the liquid contents are used to render the liquid contents into an odiferous substance known to repel common predator animals.

13. The apparatus of claim 1 wherein the liquid contents are used to render the liquid contents into an odiferous substance known to resemble an attractant scent typical of bait used to attract game.

14. The apparatus of claim 1 wherein the liquid contents are used to render the liquid contents into an odiferous substance known to resemble an attractant scent typical of chum used to attract fish.

15. The apparatus of claim 1 wherein the liquid contents are used to render the liquid contents into a nutritionally useful mixture.

16. The apparatus of claim 1 wherein the liquid contents are used to render the liquid contents into a medically useful mixture.

17. The apparatus of claim 1 wherein rescue signaling may be accomplished by breaking at least one capsule so as to create light-versus-dark color contrast for improved day visibility by rescuers.

18. The apparatus of claim 1 wherein rescue signaling may be accomplished by breaking at least one capsule so as to create dark-versus-light color contrast for improved day visibility by rescuers.

19. The apparatus of claim 1 wherein rescue signaling may be accomplished by breaking at least one capsule so as to create luminescent color contrast for improved night visibility by rescuers.

20. The apparatus of claim 19 wherein after the capsule are mixed with water the resulting liquid contents remain safe for human consumption.
